(19) United States
(12) Patent Application Publication
(10) Pub. No.: US 2007/0130321 A1
(43) Pub. Date: Jun. 7, 2007

(54) Event detection and reporting for a mobile electronic device

(75) Inventor: John O'Shaughnessy, Brunton (GB)

Correspondence Address: ST. ONGE STEWARD JOHNSTON & REENS, LLC, 986 BEDFORD STREET, STAMFORD, CT, 06905-5619, US

(73) Assignee: GPXS Holding Ltd.

(21) Appl. No.: 11/291,579

(22) Filed: Dec. 1, 2005

(51) Int. Cl. G06F 15/173

(52) U.S. Cl. 709/224

(57) ABSTRACT

Disclosed is an event detection and reporting system for a mobile device, including a controller for detecting events on the mobile device, a database accessible by said controller and containing the type of information to be logged for different types of events, software executing on the controller for determining the type of information to be logged for a detected event, and software executing on said controller for storing information about at least some detected events to generate a log.

### FIELD OF THE INVENTION

The invention relates to mobile electronic devices, and more specifically to a system and method for the detecting the events occurring on a mobile electronic device and reporting such events.

### BACKGROUND OF THE INVENTION

Mobile electronic devices, such as the Blackberry, have become common place in a many industries and professions. Organizations generally invest in mobile devices and the associated infrastructure to increase the accessibility and effectiveness of their employees. It is therefore important that measures are taken to ensure that such mobile devices are being deployed cost-effectively and in a way that supports business goals.

Particularly in the legal profession and consulting industries, employees are often responsible for accurately reporting the time they devote to each of their various clients throughout a work day. When a client is receiving the professional's time at an hourly rate, for example, it is important that the time spent working for the client while out of the office is reported just as accurately as time spent in the office.

However, it is often difficult to track and record each and every activity or event that is performed for a client while on the go. Some software applications exist to manually create a record of some activities performed on a mobile device (e.g., a phone call). Generally such applications require the user to remember to identify or tag each particular activity, input information about the activity (e.g., duration, etc), and manually transmit the information to a server. As a result, many activities are often forgotten or not accurately reported. Further, seemingly insignificant activities such as an email reply or text message to a client may go unreported, though over time such activities may add up to a substantial loss of revenue.

In addition to reporting revenue generating activities, organizations also have an interest in receiving information related to malfunctions of the mobile device. For example, an organization may wish to have a record of any hardware or software malfunctions that may inhibit the effectiveness of the mobile device and therefore the user of the mobile device.

It is therefore desired to provide a system and method for automatically detecting activities and events via a mobile device and accurately reporting the detected events.

### SUMMARY OF THE INVENTION

According, it is an object of the present invention to provide an event detection and reporting system for mobile devices.

It is a further object to provide a method of detecting and reporting events on mobile devices.

These and other objectives are achieved by providing an event detection and reporting system for a mobile device, including a controller for detecting events on the mobile device, a database accessible by said controller and containing the type of information to be logged for different types of events, software executing on the controller for determining the type of information to be logged for a detected event, and software executing on said controller for storing information about at least some detected events to generate a log.

Some embodiments of the event detection and reporting system further include software executing on the controller for generating a prompt and software executing on the controller for receiving information in response to the prompt, wherein the information includes a user input.

Further provided is a method of detecting and reporting an event on a mobile device, including the steps of monitoring a mobile device for the occurrence of an event, determining whether to log a detected event, determining the type of information to be logged for the detected event; and storing information about at least some detected events.

### BRIEF DESCRIPTION OF THE DRAWINGS

FIG. 1 is schematic diagram of an event detection and reporting system according to the present invention.

FIG. 2 is another schematic diagram of the event detection and reporting system shown in FIG. 1.

FIG. 3 is method of detecting and reporting an event on a mobile device employable by the system shown in FIGS. 1 and 2.

### DETAILED DESCRIPTION OF THE INVENTION

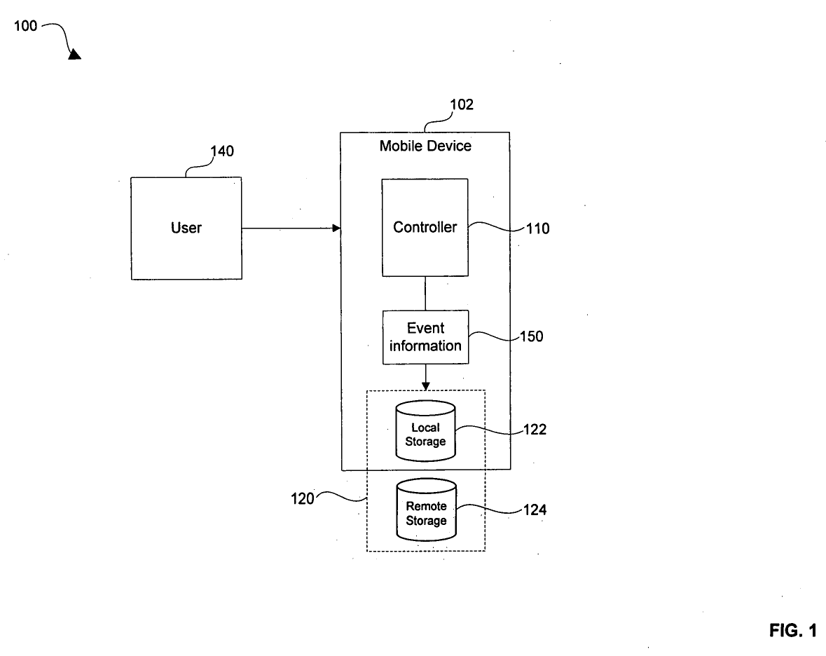

FIG. 1 shows an event detection and reporting system 100 according to the present invention. The system 100 includes a mobile device 102. The mobile device 102 may be any transportable electronic device preferably having wireless capabilities, including, but not limited to, a mobile phone, a personal digital assistant (“PDA”), a smart phone, a handheld, a PocketPC, or a notebook computer.

The mobile device 102 includes a controller 110. The controller 110 may be any device, system or part thereof that controls at least one operation and/or receives and executes software programs. The controller 110 may be implemented in hardware, firmware or software, or some combination of at least two of the same. For example, the controller 110 may selected from a group consisting of digital signal processors, microcontrollers, microprocessors, and computer programmable logic devices. It should be noted that the functionality associated with the controller 110 may be centralized or distributed, whether locally or remotely.

The controller 110 executes one or more software programs on the mobile device 102. In particular, the controller 110 executes software for detecting activities or events. The controller 110 may detect any number of events (e.g., activities, tasks, functions) occurring on, in relation to, the mobile device 102. For example, the controller 110 of the mobile device 102 may detect interactions with a user 140 of the mobile device (e.g., via a user interface) or interactions between the mobile device 102 and other devices.

The controller 110 may further execute software for storing information about some of the detected events (e.g., event information 150). For example, the event information 150 may be stored in a storage 120. As one of ordinary skill in the art will understand, the dashed lines of the storage 120 in FIG. 1 are intended to indicate that the storage 120 may be physically located on the mobile device 102 or at another location external to the mobile device 102. As shown, the storage 120 may include a local storage 122 (e.g., upon the mobile device 102) and/or a remote storage 124 (e.g., being in direct or wireless communication with the mobile device 102). Further, the local storage 122 and/or remote storage 124 may include any number of databases (not shown).

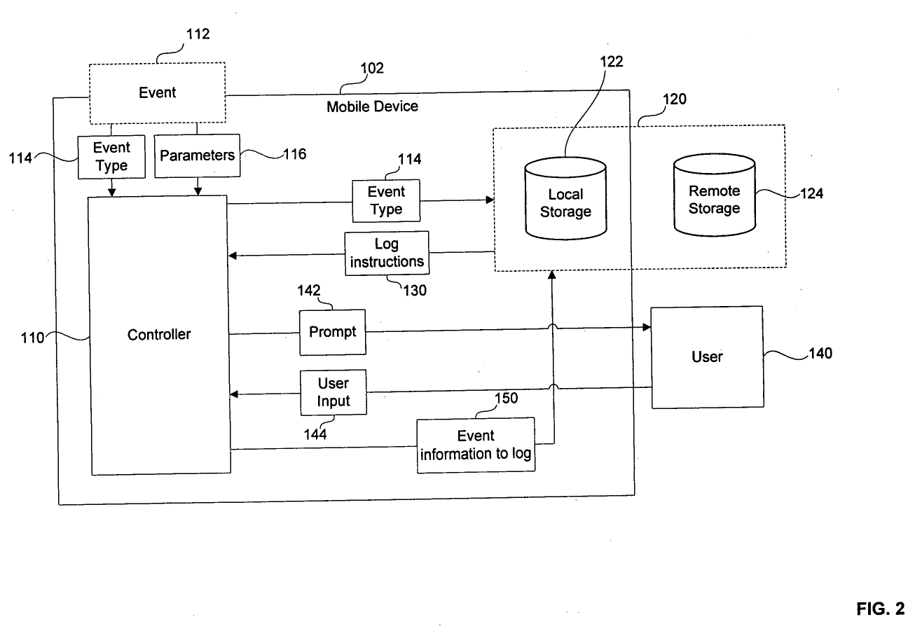

FIG. 2 shows another view of the event detection and reporting system 100 according to the present invention. As shown, the controller 110 may detect any number of events 112 (e.g., activity, task, or function) occurring on, or in relation to, the mobile device 102. For example, the controller 110 may detect a telephone call, an email (e.g., being drafted, sent, received, or read), and/or a text message or SMS message. The controller 110 may further detect a print command, fax command, a purchase, a wireless data transmission (e.g., Bluetooth®, Wi-Fi), and/or an electronic file access upon the mobile device (e.g., via a remote server). The controller 110 may also detect malfunctions of the mobile device 102 or any software resident thereon (e.g., software crashes, hardware problems, loss of wireless reception) and usage of the resident software (i.e., usage profiling). As one of ordinary skill in the art will understand, an event may occur external to the mobile device 102 but be otherwise detectable (e.g., wirelessly) by the mobile device 102.

In some embodiments, the controller 110 may determine an event type 114 (e.g., phone call, etc) of the detected event 112. The controller 110 may then determine whether the detected event 112 should be logged based on the event type 114. For example, the controller 110 may query a database (e.g., in the local storage 122 and/or remote storage 124) containing data indicative of whether to log the event. In some embodiments, the database may further include exceptions data pertaining to an event type or a particular event (e.g., based on user preferences).

The system 100 includes a database (e.g., in the local storage 122 and/or remote storage 124) containing type of information to be logged for different types of events. Further included is software executing on the controller 110 for determining the type of information to be logged for the detected event 112 (e.g., via log instructions 130). For example, the database may indicate that a duration, phone number, and client identification must be collected and logged for a detected phone call. However, the information may include any number of parameters, characteristics, or identifying information related to the event such as a matter identifier, billing convention, subject, event summary, etc.

The system 100 may include software executing on the controller 110 for collecting information or parameters 116 from the detected event 112. The system 100 may also include software executing on the controller 110 for generating a prompt 142 and receiving a user input 144 regarding the detected event 112. For example, if a user input 144 is required, a prompt 142 may be provided to a user 140 of the mobile device 102, e.g., via a user interface. The prompt 142 may include a request for specific information relating to the event 112 (e.g., event summary, billable amount and/or rate, etc). In some cases, the prompt 142 may include a request to the user 140 to provide input indicative of whether or not to log the event 112. The user 140 may then provide a user input 144.

The system 100 includes software executing on controller 110 for storing information about the detected event 112 (e.g., event information 150). The event information 150 may include any information necessary to log the event 112, such as the parameters 116 and user input 144. The event information 150 may be stored in the local storage 122 on the mobile device 102. The event information 150 may also be stored in a remote storage 124, e.g., in a log or log database (not shown) containing a plurality of logged events. The event information 150 may be also supplemented with information stored in the local storage 124 or remote storage 124 to complete a record of the event.

The event information 150 or record may also be arranged or formatted as desired. For example, the event information 150 and/or record may be formatted to be compatible with any time-keeping application. The event information 150 and/or record may also be formatted into a timesheet or client invoice. In some other embodiments, the event information 150 or record may be wirelessly transmitted to an output device such as a printer or fax.

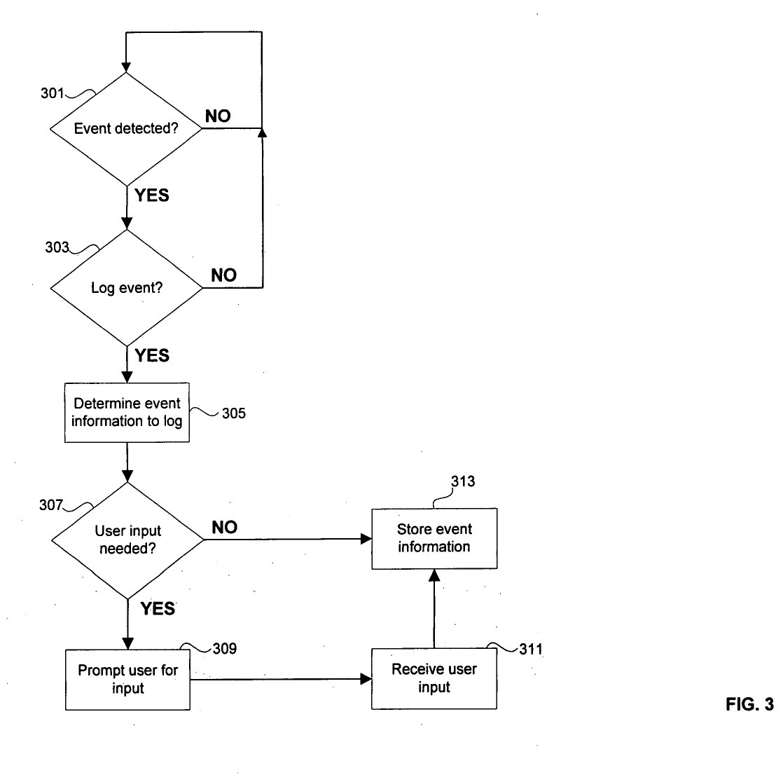

FIG. 3 shows a method of detecting and reporting an event on a mobile device. The method is described with respect to the system 100 shown in FIGS. 1 and 2. However, one of ordinary skill in the art will understand that the method may be implemented in other systems and mobile devices.

The method includes a first step 301 of monitoring a mobile device for the occurrence of an event. If an event is detected, a determination is then made as to whether to log the detected event (step 303). This determination may include determining an event type of the event and determining whether to log the event based on the event type. For example, the determination may be performed by querying a database containing data indicative of whether to log the event. Further, the determination may include retrieving log instructions based on the event type from the database.

The method further includes a step 305 of determining the type of information to be logged for the detected event. For example, it may be determined that particular information must be collected from the detected and event and other information must be requested from a user. If user input is needed (step 307), a prompt is generated for a user input regarding the event (step 309). Next, the user input is received in step 311.

In step 311, event information is stored. For example, the event information may be stored in a local storage upon the mobile device. The event information may alternatively (or in combination) be transmitted or delivered to a remote storage. The data may be transmitted wirelessly to the remote storage, or delivered via a direct connection such as USB cable and/or docking assembly.

In operation, the present invention provides a means to detect relevant events on a mobile device and provide information about the events to a user, an organization, and/or a client. For example, a user may draft and send an email message to a client via his mobile device. The system will detect the event beginning when the user first accesses the compose function on his mobile device. The system will identify the event as an email and determine what information needs to be collected and logged for the email. For example, the system may determine that it needs to collect a time (i.e., duration of time to compose and send and/or a time stamp), recipient information, subject, and client/matter identifiers from the email. The system may additionally identify information specific to the particular sender, client or matter that needs to be logged (e.g., based on user or client preferences).

If additional information is needed from the user, the system will generate a prompt (e.g., on a user interface of the mobile device) to request information from the user. The user may then provide user input regarding the detected event. Information about the detected event may then be stored either on the mobile device or remotely. For example, the information may be transmitted to a remote storage. The information may then be formatted, if necessary, and added to a log of detected events (e.g., attorney's time-keeping database). The information may also be transmitted directly to the client via fax, email, etc. in the form of a client invoice.

In another operation of the present invention, the system may detect a purchase occurring via a mobile device. For example, the purchase may be Bluetooth purchase at a Bluetooth enabled vending machine. Alternatively, the purchase may be a RFID purchase, such as a RFID payment at a toll booth (e.g., EZ-Pass). The system may then determine that it needs to collect and log information regarding the purchase such as the location of the purchase, amount, and time. The system may additionally determine that it needs to ask the user to identify a client, if any, to bill the purchase to. Information about the purchase is then stored locally on the mobile device and/or in a remote storage (e.g., at user's office). The information may then be used to build a log (e.g., expense account) or added to an existing log associated with the particular client.

Although the invention has been described with reference to a particular arrangement of parts, features and the like, these are not intended to exhaust all possible arrangements or features, and indeed many modifications and variations will be ascertainable to those of skill in the art.

What is claimed is:

1. An event detection and reporting system for a mobile device, comprising:
a controller for detecting events on the mobile device;
a database accessible by said controller and containing the type of information to be logged for different types of events;
software executing on the controller for determining the type of information to be logged for a detected event; and
software executing on said controller for storing information about at least some detected events to generate a log.

2. The event detection and reporting system according to claim 1, further comprising:
software executing on the controller for collecting information from the detected event.

3. The event detection and reporting system according to claim 2, wherein the information includes an event duration.

4. The event detection and reporting system according to claim 2, wherein the information includes a client identifier.

5. The event detection and reporting system according to claim 4, further comprising:
software executing on said controller for determining whether the client identifier corresponds with one a plurality of valid client identifiers.

6. The event detection and reporting system according to claim 5, further comprising:
software executing on the controller for generating a prompt if the client identifier corresponds with a valid client identifier; and
software executing on the controller for receiving information in response to the prompt, wherein the information includes a user input.

7. The event detection and reporting system according to claim 2,
wherein the information includes a matter identifier.

8. The event detection and reporting system according to claim 1, further comprising:
software executing on the controller for generating a prompt; and
software executing on the controller for receiving information in response to the prompt, wherein the information includes a user input.

9. The event detection and reporting system according to claim 8, wherein the user input includes an event summary.

10. The event detection and reporting system according to claim 8,
wherein the user input includes a client identifier.

11. The event detection and reporting system according to claim 8, wherein the user input includes a matter identifier.

12. The event detection and reporting system according to claim 1, wherein the detected event is one of an SMS, a phone call, or an email.

13. The event detection and reporting system according to claim 1, wherein the detected event is one of a print command, fax command, a purchase, or a wireless data transmission.

14. The event detection and reporting system according to claim 1, wherein the detected event is a malfunction of the mobile device.

15. The event detection and reporting system according to claim 1, wherein the detected event is an electronic file access upon the mobile device.

16. The event detection and reporting system according to claim 1,
wherein the database is located in one of a local storage or remote storage.

17. The event detection and reporting system according to claim 1,
wherein the information about at least some detected events is stored remotely in a log database.

18. The event detection and reporting system according to claim 17,
wherein the log database is located in one of a local storage or remote storage.

19. A method of detecting and reporting an event on a mobile device, comprising the steps of:
monitoring a mobile device for the occurrence of an event;
determining whether to log a detected event;
determining the type of information to be logged for the detected event; and
storing information about at least some detected events.

20. The method according to claim 19, further comprising the steps of:
generating a prompt for a user input regarding the detected event; and
receiving the user input.

21. The method according to claim 19, further comprising the step of:
collecting information from the detected event.

22. The method according to claim 19, further comprising the step of:
generating a log of detected events.

23. The method according to claim 19, wherein the step of determining whether to log includes determining a client associated with the event and accessing a database to validate the client.

24. The method according to claim 23, further comprising the steps of:
generating a prompt for a user input regarding the detected event if the event is associated with a valid client; and
receiving the user input.

25. The method according to claim 23, further comprising the step of:
generating a log of detected events associated with valid clients.

26. The method according to claim 19,
wherein the log is a client invoice.
